(19) United States
(12) Patent Application Publication
(10) Pub. No.: US 2012/0166036 A1
(43) Pub. Date: Jun. 28, 2012

(54) Diagnosis method for implementing a system diagnosis

(75) Inventors: Damian Dyrbusch, Ludwigsburg (DE); Dean Sarcevic, Waiblingen-Hohenanker (DE)

(73) Assignee: Robert Bosch GMBH, Stuttgart (DE)

(21) Appl. No.: 13/381,697

(22) PCT Filed: Jun. 30, 2010
(86) PCT No.: PCT/EP10/59298

§ 371 Date: Mar. 19, 2012

(30) Foreign Application Priority Data
Jul. 1, 2009 (DE) 10 2009 027 375.1

(51) Int. Cl. G01M 17/00

(52) U.S. Cl. 701/32.1

(57) ABSTRACT

In a diagnosis method for performing a system diagnosis, e.g., a diagnosis of a physical system, the system is transferred into a plurality of predefined system states, a system characteristic of the system is acquired in at least two system states of the plurality of predefined system states so as to obtain a state-specific curve of the system characteristic, and the state-specific curve of the system characteristic is analyzed in order to obtain a diagnosis result.

### BACKGROUND OF THE INVENTION

1. Field of the Invention

The present invention relates to the field of system diagnoses, e.g., especially diagnoses of vehicle-specific systems.

2. Description of Related Art

To monitor and diagnose complex physical systems such as hydraulic systems of injection systems in vehicles, the system components are usually checked according to a predefined test scheme with the aid of monitoring and diagnosis functions.

FIG. 1 shows an exemplary realization of diagnosis and monitoring functions 101, 103, 105, 107, and 109 featuring different starting conditions. For example, functions 101 and 105 have starting condition A, function 109 has starting condition B, function 107 has starting condition C, and function 103 has starting condition D. The mutual blocking of functions is illustrated by arrows 111 shown in FIG. 1. According to this, for example, function 107 is blocked when function 101 is executed, so that it is able to be carried out only after function 101 has been executed. Functions 101 through 109 may be performed one after the other, an individual result analysis being undertaken as described in the printed publication by Tonguc Ünlüyurt, Sequential Testing of Complex Systems: A Review, Elsevier, Discrete Applied Mathematics, 142 (2004).

A disadvantage of the known diagnosis concepts, especially for performing a system diagnosis in injection systems, is the often insufficient overview of the implemented monitoring and diagnosis functions. Furthermore, greater effort is often required to determine which diagnosis function is executed at which time, which is the case in particular when the monitoring and diagnosis functions have different enabling conditions. Furthermore, the known diagnosis concepts do not allow a rapid and reduced-cost diagnosis of an overall system, because they always have a complete diagnosis of the individual system components as their basis.

### BRIEF SUMMARY OF THE INVENTION

The present invention is based on the recognition that a system diagnosis possibly involving both testing and monitoring of the system which may have a plurality of system components, is able to be carried out efficiently and at reduced effort if it is performed in two stages. The system diagnosis is preferably subdivided into individual subtests, i.e., diagnosis functions, which run one after the other, i.e., sequentially, it being possible to define a duration and a sequence of the subtests. The individual subtests are preferably performed sequentially, without analyzing the diagnosis results in this first stage. Instead, for example, the individual diagnosis function supplies the system characteristic associated therewith, so that a curve of the system characteristic specific to the function and state is made available at the end of the first stage. To diagnose the system, the curve of the system characteristic may be analyzed in a second stage, for which, for example, different state-specific system characteristics may be linked with each other in order to diagnose the system. Thus, a single test is performed for the entire system, without checking the individual system components while implementing the test for the occurrence of a fault, which allows for a rapid system diagnosis. Furthermore, the system diagnosis may be triggered by a single signal common to all functions, so that the current diagnosis status is known at all times.

According to one aspect, the present invention relates to a diagnosis method for performing a system diagnosis, especially a diagnosis of a physical system, which encompasses the steps of transferring the system into a plurality of predefined system states, recording a characteristic curve of the system in at least two system states of the plurality of predefined system states, in order to obtain a state-specific curve of the system characteristic, and analyzing the state-specific characteristic curve of the system characteristic in order to obtain a diagnosis result. For example, the system is transferred into a system state when a diagnosis function is executed. For this purpose, for instance, one of the system components can be transferred into a state specific to the system component, such as switch-on or switch-off state. The particular system characteristic thus is a response of the system to the execution of the individual diagnosis function, i.e., the behavior of the system in the particular system state, which is able to be induced by a system test, for instance. Thus, the curve of the system characteristic may include a curve of test results or of partial test results, for example.

According to one advantageous specific embodiment, the system characteristic is not analyzed in the step in which the system characteristic is recorded, so that the diagnosis is able to be performed rapidly.

According to one advantageous specific embodiment, the sequence of the system states and/or the dwell time of the system in the particular system state are/is predefined. In this way the diagnosis of the system is always able to be implemented in a defined manner and a manner specific to the system components.

According to one advantageous specific embodiment, the system characteristic is detected in each predefined system state of the plurality of system states, so that a comprehensive system diagnosis is able to be performed quite rapidly.

According to one advantageous specific development, the system is sequentially transferred into the plurality of predefined, sequentially occurring system states, so that mutual blocking of the diagnosis function which transfers the system into the particular state is advantageously preventable in efficient manner.

According to one advantageous specific embodiment, the system includes a plurality of system components; to transfer the system into the system states, at least one of the system components is transferred into a predefined system component state or into a sequential succession of system component states, or a plurality of system components is transferred into a sequential succession of system component states, or the system is excited to transfer the system into the system states on the input and/or output side, sequentially and in different manners, for example. This enables a successive and uncomplicated acquisition of the curve of the system characteristics.

According to one advantageous specific embodiment, the system includes a plurality of system components, the system characteristic being associated with a method of functioning or a system-component state of the individual system component of the system. This readily ensures that the system characteristic or the curve thereof is related to the system component.

According to one advantageous specific development, the system states are pressures such as air pressures or fuel pressures, or torques or currents or voltages. In general, the system states are physical states of the system which come about in response to a physical excitation of the system.

According to one advantageous specific embodiment, the system is a vehicle system or a hydraulic system, e.g., a hydraulic actuating system for a vehicle clutch, or a fuel injection system or an electronic vehicle system or an energy supply system of a vehicle such as a vehicle electrical system or a drive system of the vehicle, e.g., a hybrid drive having at least two drive sources, or a vehicle control system.

According to one advantageous specific embodiment, the system may be a fuel-injection system, which has a closing valve on the input side, a dosing valve connected downstream from the input-side closing valve, a first sensor situated between the input-side closing valve and the dosing valve, e.g., a pressure or temperature sensor, and a second sensor connected downstream from the closing valve, it being possible to transfer the system into the plurality of system states by opening and/or closing the input-side closing valve or a dosing valve connected downstream from the closing valve; the curve of the system characteristic is detected with the aid of the first sensor, and a further curve of the system characteristic, with the aid of the second sensor. Preferably, a common analysis of the characteristic curve and the further curve of the system characteristics is performed in order to obtain the diagnosis result. The curve and the further curve of the system characteristics may also be linked for this purpose.

According to one advantageous specific embodiment, physical signals, especially pressure signals or electronic signals, are acquired for detecting the system characteristic or the behavior thereof, so that a signal-based analysis of the state-specific curve of the system characteristic is able to be performed in an advantageous manner.

According to one further aspect, the present invention relates to a vehicle control device for performing a diagnosis of a system which includes a device for transferring the system into a plurality of predefined system states, a device for detecting a system characteristic of the system in at least two system states of the plurality of the predefined system states, in order to obtain a state-specific curve of the system characteristic, and a device for analyzing the state-specific characteristic curve of the system characteristic in order to obtain a diagnosis result.

Additional features of the vehicle control device result directly from the features of the diagnosis method according to the present invention.

According to one advantageous specific embodiment, the devices of the vehicle control device are realized in software or in hardware.

According to one further aspect, the present invention relates to a computer program having program code for executing the diagnosis method when the computer program runs on a computer.

According to one further aspect, the present invention relates to a diagnosis device set up with software, e.g., a control device, designed to execute the computer program.

### BRIEF DESCRIPTION OF THE DRAWINGS

FIG. 1 shows a sequence of a system diagnosis.

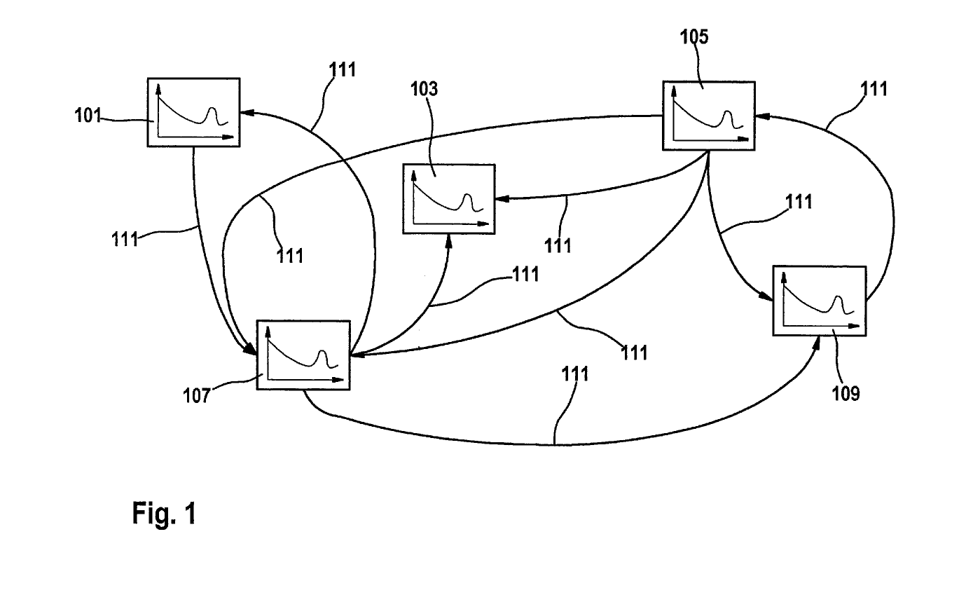

FIG. 2 shows a diagram of a diagnosis method according to the invention.

FIG. 3 shows a diagram of a diagnosis method.

FIG. 4 shows a system to be diagnosed.

FIGS. 5a and 5b show curves of the system characteristics.

### DETAILED DESCRIPTION OF THE INVENTION

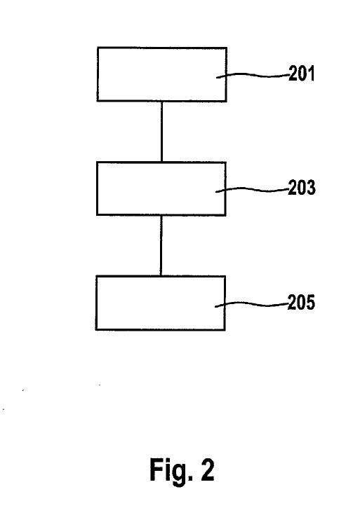

FIG. 2 shows a diagnosis method for performing a diagnosis of a system, which method has step 201 of transferring the system into a plurality of predefined system states, step 203 for detecting a system characteristic of the system in at least two system states of the plurality of predefined system states in order to obtain a state-specific curve of the system characteristic, and step 205 of analyzing the state-specific curve of the system characteristic in order to obtain a diagnosis result.

The flow chart shown in FIG. 2 simultaneously illustrates a structure of a vehicle control device equipped with a device for transferring 201 the system into a plurality of predefined system states, a device for detecting 203 a system characteristic of the system in at least two system states in order to obtain a state-specific curve of the system characteristic, and a device for analyzing 205 the state-specific curve of the system characteristic in order to obtain a diagnosis result.

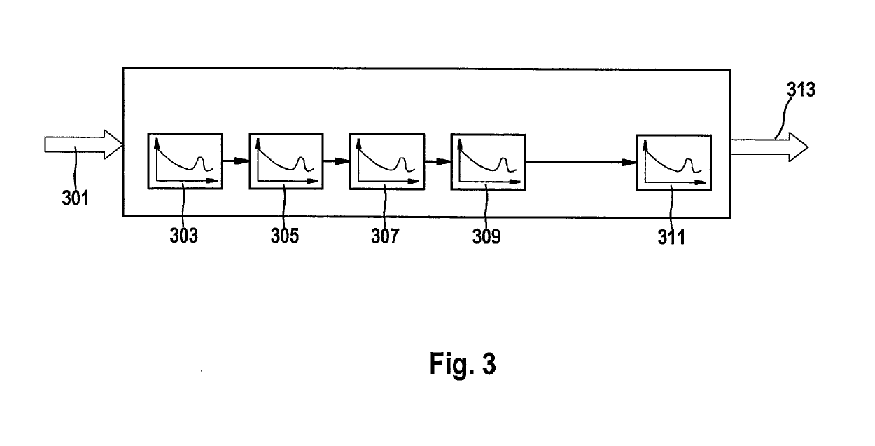

FIG. 3 shows a sequence of a diagnosis method, which is implemented for the system test, in which the system, responding to a release 301, is transferred into a plurality of predefined system states 303, 305, 307, 309, and 311 by executing a particular diagnosis function. A system characteristic is acquired in each state 303 through 311, and the resulting curve of the system characteristic is analyzed subsequently. The end of the diagnosis is indicated by an exit signal 313, for instance.

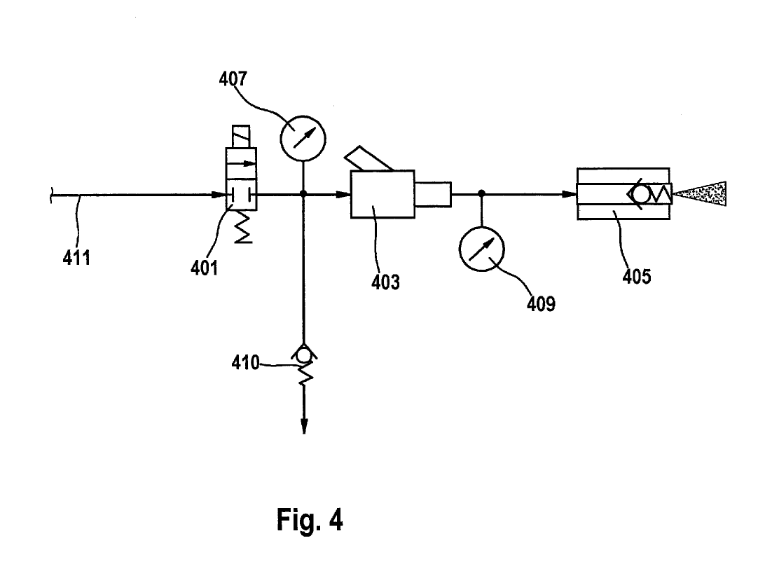

FIG. 4 shows an exemplary system to be diagnosed, which has a closing valve 401 disposed on the input side, a dosing valve 403 downstream from closing valve 401, an injection valve 405 downstream from the dosing valve 403, a pressure or temperature sensor 407, which is disposed between valves 401 and 403, another pressure or temperature sensor 409, which is disposed between valves 403 and 405, as well as an overflow adapter 410, which is mounted between valves 401 and 403.

The system shown in FIG. 4 is an injection system of a motor vehicle, for instance, to which pressure 411 is applied on the input side. For a system diagnosis, for example, valves 401, 403 or 405 may be opened or closed according to a predefined scheme, thereby transferring the system into a succession of sequential states. However, valve 405 may be pressure-controlled and opened when an opening pressure is present, or closed when no opening pressure is present, it being possible for the opening pressure to be a function of a state of valves 401 and/or 403. The system characteristic, or the temporal or state-specific curve thereof, may be acquired with the aid of sensor 407, for instance. Using sensor 409, the system characteristic or a further curve thereof is detectable at another system location. Both curves of the system characteristics are able to be utilized for the purpose of analyzing the system behavior.

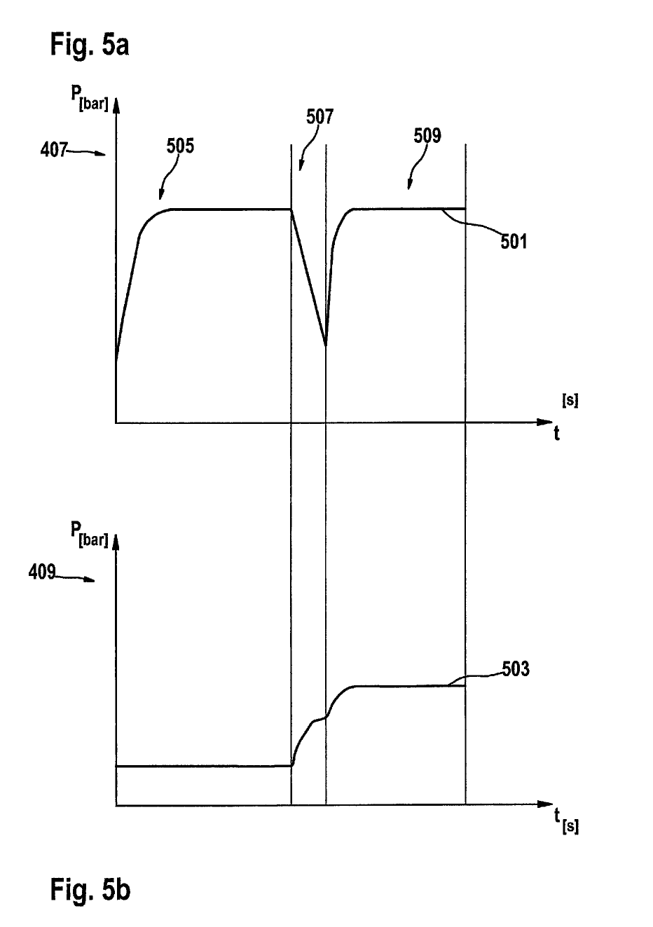

FIG. 5 shows curves of the system characteristics detected as described earlier, FIG. 5a showing a curve 501 of the system characteristics acquired by means of sensor 407, and FIG. 5b showing a curve 503 of the system characteristic over time acquired by means of sensor 409. Preferably, the system is transferred into a succession of states 505 through 519 in sequential manner, a system characteristic, e.g., a system pressure P, being detected in each state.

For example, in order to transfer the system into state 505 shown in FIG. 5a, valve 401 is opened and valve 403 is closed.

For the subsequent transfer of the system into state 507, valve 401 is closed and valve 403 is opened. For the subsequent transfer of the system into state 509, valve 401 is opened and valve 403 is opened.

The system characteristics 501 and 503 shown in FIGS. 5a and 5b, for instance, are resulting pressure curves which are detected by means of sensor 407 or sensor 409. Both pressure curves 501 and 503 represent an individual curve of the system characteristic, which is picked off or acquired at different system locations. With the aid of a shared analysis of the system characteristics shown in FIGS. 5a and 5b, the system shown in FIG. 4 is able to be diagnosed in comprehensive manner.

1-15. (canceled)

16. A diagnosis method for performing a diagnosis of a physical system of a vehicle, comprising:
transferring the system into a plurality of predefined system states;
acquiring a system characteristic of the system in at least two of the plurality of predefined system states, in order to obtain a state-specific curve of the system characteristic; and
analyzing the state-specific curve of the system characteristic to obtain a diagnosis result.

17. The diagnosis method as recited in claim 16, wherein the system characteristic is not analyzed in the step of acquiring the system characteristic.

18. The diagnosis method as recited in claim 16, wherein at least one of (i) a succession of the system states and (ii) a dwell time of the system in one of the predefined system states is predefined.

19. The diagnosis method as recited in claim 16, wherein the system characteristic is acquired in every one of the predefined system states.

20. The diagnosis method as recited in claim 16, wherein the system is transferred into the plurality of the predefined system states in sequential manner.

21. The diagnosis method as recited in claim 16, wherein the system has a plurality of system components, and wherein one of:
(i) at least one of the system components is transferred into one of a predefined system component state or a sequential succession of system component states in order to transfer the system into the predefined system states; or
(ii) the system is sequentially excited on at least one of the input side and the output side in order to transfer the system into the predefined system states.

22. The diagnosis method as recited in claim 16, wherein the system has a plurality of system components, and the system characteristic is assigned to a system component state of a particular system component of the system.

23. The diagnosis method as recited in claim 16, wherein the system states include at least one of pressures, torques, currents and voltages.

24. The diagnosis method as recited in claim 16, wherein the system is one of: a hydraulic system; a fuel injection system; a vehicle electronic system; a vehicle energy supply system; a vehicle drive system; or a vehicle control system.

25. The diagnosis method as recited in claim 16, wherein:
the system includes an input-side closing valve, a dosing valve downstream from the input-side closing valve, a first sensor disposed between the input-side closing valve and the dosing valve, and a second sensor downstream from the dosing valve;
the system is transferred into the plurality of predefined system states by at least one of opening and closing the input-side closing valve;
the state-specific curve of the system characteristic is detected by the first sensor;
a further curve of the system characteristic is detected by the second sensor; and
a common analysis of the state-specific curve and the further curve of the system characteristic is carried out.

26. The diagnosis method as recited in claim 16, wherein one of (i) pressure signals or (ii) electronic signals are acquired in order to detect the system characteristic.

27. A vehicle control system having a diagnosis function for implementing a diagnosis of a physical system of a vehicle, comprising:
a device for transferring the system into a plurality of predefined system states;
a device for acquiring a system characteristic of the system in at least two of the plurality of predefined system states, in order to obtain a state-specific curve of the system characteristic; and
a device for analyzing the state-specific curve of the system characteristic to obtain a diagnosis result.

28. A non-transitory computer-readable data storage medium storing a computer program having program codes which, when executed on a computer, performs a diagnosis method for performing a diagnosis of a physical system of a vehicle, the method comprising:
transferring the system into a plurality of predefined system states;
acquiring a system characteristic of the system in at least two of the plurality of predefined system states, in order to obtain a state-specific curve of the system characteristic; and
analyzing the state-specific curve of the system characteristic to obtain a diagnosis result.
